(19) United States
(12) Patent Application Publication
(10) Pub. No.: US 2009/0137423 A1
(43) Pub. Date: May 28, 2009

(54) Micro-electrode array

(76) Inventor: Seamus Patrick John Higson, Bedfordshire (GB)

Correspondence Address: Bracewell Giuliani LLP, PO Box 61389, Houston, TX, 77208-1389, US

(21) Appl. No.: 11/579,248

(22) PCT Filed: Apr. 28, 2005
(86) PCT No.: PCT/GB2005/001634

§ 371 Date: Aug. 17, 2007

(30) Foreign Application Priority Data
May 1, 2004 (GB) 0409809.1

(51) Int. Cl. C40B 30/10; C40B 50/18; C40B 40/00

(52) U.S. Cl. 506/12; 506/32; 506/13

(57) ABSTRACT

A method of fabricating a micro-electrode array comprising the steps of coating an electrode with an insulating polymer coating by screen printing an insulating polymer onto the electrode and then curing said polymer; and sonically ablating the insulating polymer coating to produce a plurality of micro-pores.

This invention relates to micro-electrode arrays, methods of fabricating same, and methods of sensing an analyte using a micro-electrode array.

International Publication No. WO 96/33403 discloses an analyte sensor in which a conductimetric property is measured across a working electrode—counter-electrode plane in the presence of the analyte. The working electrode is a micro-electrode array comprising a plurality of micro-pores, in which a conducting organic polymer is deposited discretely in the micro-pores. The micro-electrode arrays are fabricated using a variation of the technique described in Madigan et al (J. Electrochem. Soc., Vol 141, No. 3, March 1994). Madigan et al discloses the preparation of micro-array electrodes by sonochemical ablation of polymer films, and presents electrochemical data obtained with such electrodes, but does not disclose the use of such electrodes as analyte sensors. The contents of Madigan et al and WO 96/33403 are incorporated herein by reference.

The present invention provides improved micro-electrode arrays, methods of fabricating same, and methods of sensing an analyte using a micro-electrode array.

According to a first aspect of the invention there is provided a method of fabricating a micro-electrode array comprising the steps of:

coating an electrode with an insulating polymer coating by screen printing an insulating polymer onto the electrode and then curing said polymer;

and sonically ablating the insulating polymer coating to produce a plurality of micro-pores.

Curing may be accomplished by a number of means which might include, for example, a heat treatment, a chemical treatment, or exposure to UV light, X-rays or gamma rays.

The insulating polymer may be, for example, polydiaminobenzene, PVC, Teflon®, polyethylvinylbenzene and the like. In some embodiments a commercial ‘dielectric’ polymer film or ‘resist’ as used within the electronics industry may be screen printed onto the electrode.

The electrode may be formed from any suitable conductive material such as gold, platinum or carbon. The electrode may be deposited as a surface onto a substrate via sputtering, vapour deposition or any other suitable deposition technique. Alternatively, the electrode may be formed by screen printing, such as by screen printing a conductive ink onto a substrate. Generally, the electrode is planar, although other configurations are at least conceivable.

Further fabrication steps may be employed. For example, the method may further comprise the step of depositing a second polymer onto the micro-electrode array. The deposition of the second polymer may be in accordance with International Publication No. WO 96/33403 and/or with the methods described below. The deposition of the second polymer may be performed so as to produce a micro-electrode array of the type described below. The second polymer may be conducting or non-conducting. Furthermore, the second polymer may be deposited discretely at the sites of the micro-pores (such as described, in the context of conducting polymers, in WO 96/33403) or over substantially the entire array.

In another further fabrication step, an analyte reagent is disposed on the micro-electrode array in accordance with International Publication No. WO 96/33403 and/or with the methods described below. The analyte reagent may be disposed so as to produce a micro-electrode array of the type described below. The analyte reagent can be directly deposited onto the micro-electrode array, immobilised in a matrix, deposited onto the surface of a matrix or immobilised on the surface of a matrix by a number of different means such as by, for example, covalent bonding to the surface. The matrix may be the second polymer, which may be conducting or non-conducting. The analyte reagent can be any moiety which interacts with an analyte so as to produce (either directly or indirectly) a perturbation to a sensing system which can be measured using the micro-electrode array. The analyte reagent may participate in a redox process or be a component of a buffer. The analyte reagent may be an inorganic chemical (such as a salt), organic (such as a monomer), a polymer, or of biological origin or type, such as an enzyme, aptamer, antibody, antigen, or nucleic acid such as DNA or RNA—or an oligionucleotide chain.

According to a second aspect of the invention there is provided a method of sensing an analyte comprising the steps of:

contacting a micro-electrode array with an analyte containment medium, which analyte containment medium contains the analyte;

interrogating the micro-electrode array by polarising the micro-electrodes and monitoring an electrical property that varies due to electrochemistry associated with the analyte; and

correlating the electrical property monitored with the presence of the analyte;

in which the micro-electrode array is interrogated using a voltammetric, potentiometric or capacitive technique.

The analyte containment medium may be a conducting solution, preferably an aqueous solution. It is also within the scope of the invention to immobilise the analyte (and/or an analyte reagent) at the micro-electrode array in a suitable manner, such as by immobilisation within a matrix. The matrix in which an analyte is immobilised may be of a type described below in the context of immobilising an analyte reagent.

The micro-electrode array may be interrogated using linear sweep voltammetry, cyclic voltammetry, square wave voltammetry or pulse voltammetry. AC polarising potentials, combined potential waveforms of a dc bias potential and an ac potential waveform, and non-ac potential time varying waveforms may be used.

The micro-electrode may be interrogated by monitoring the current flowing between the micro-electrode array and a counter electrode. In this instance, the micro-electrode array serves as a working electrode. In some embodiments, a plurality of micro-electrode arrays are employed in conjunction with a common counter electrode. Additionally, a reference electrode may be employed.

The micro-electrode array may be interrogated by monitoring the potential difference between the micro-electrode array and a second electrode. The second electrode may be a reference electrode, or a counter electrode. The charge accumulated (potential difference) at the surface of the micro-electrode array with respect to the second electrode may be monitored. A potentiometric or a capacitive property may be monitored.

The micro-electrode array may comprise an analyte reagent deposited across a plurality of micro-electrodes. The analyte reagent may be deposited as a layer across a substantial portion of the micro-electrode array so as to cover a plurality of micro-electrodes. Alternatively, the analyte reagent may be deposited discretely at a plurality of micro-electrodes.

There are a number of ways in which the analyte reagent may be deposited. For example, the analyte reagent may be immobilised within a matrix, or may be deposited by direct surface adsorption onto the micro-electrode array.

The micro-electrode array may comprise a matrix such as a polymer deposited across a plurality of micro-electrodes. Alternatively, a “bare” micro-electrode array, ie, a micro-electrode array in which materials are not deposited onto the micro-electrodes, might be used. The micro-electrode array used in the sensing of the analyte may be one according to another aspect of the invention, and/or may be fabricated by a method according to another aspect of the invention.

According to a third aspect of the invention there is provided a micro-electrode array comprising:

an electrode;

an insulating polymer coating covering the electrode and having a plurality of micro-pores formed therein thereby exposing a plurality of micro-electrodes;

and further comprising at least one of:

i) an analyte reagent deposited as a layer across a substantial portion of the micro-electrode array so as to cover a plurality of micro-electrodes;

ii) an analyte reagent deposited discretely at a number of micro-electrodes either by direct surface adsorption onto the micro-electrodes or by deposition onto the micro-electrodes of a non-conducting matrix in which the analyte reagent is immobilised;

iii) a non-conducting polymer deposited across a plurality of micro-pores, and

iv) a conducting polymer deposited as a layer across a substantial portion of the micro-electrode array so as to cover a plurality of micro-electrodes.

An advantage of micro-electrode arrays is that radial transport of an analyte is possible, leading to improved analyte sensing. Surprisingly, it has been found that even embodiments in which an analyte reagent or a matrix such as a conducting polymer is deposited in a layer across the micro-electrode array can result in a radial transport regime.

In option i), above, the analyte reagent may be deposited by direct surface adsorption onto the micro-electrode array. In this instance, or in ii), above, the analyte reagent may be deposited by dip coating, spin coating, spray coating, screen printing, stencilling, an ink-jet coating technique or a spray jet coating technique.

In option i), above, the analyte reagent may be immobilised within a matrix. The matrix may be a sol-gel, a cross-linked protein, or a polymer. A polymer may be a non-conducting polymer or a conducting polymer.

In option iii), above, the non-conducting polymer may be deposited as a layer across a substantial portion of the micro-electrode array so as to cover a plurality of micro-electrodes.

In option iii), above, the non-conducting polymer may be deposited discretely at a number of micro-electrodes.

An analyte reagent may be immobilised in the non-conducting polymer.

An analyte reagent may be adsorbed onto a surface of the non-conducting polymer.

In option iv), above, an analyte reagent may be immobilised in the conducting polymer.

In option iv), above, an analyte reagent may be adsorbed onto a surface of the conducting polymer.

An analyte may be immobilised at the micro-electrode array in a suitable manner. The micro-electrode array may be produced generally in accordance with the methods described in WO 96/33403 and/or according to the methods described herein. It will be appreciated that the micro-electrodes are electrically interconnected in parallel by virtue of sharing a common underlying electrode.

According to a fourth aspect of the invention there is provided a method of fabricating a micro-electrode array comprising the steps of:

coating an electrode with an insulating polymer coating;

sonically ablating the insulating polymer coating to produce a plurality of micro-pores; and

depositing a second polymer onto the micro-electrode array by i) contacting the micro-electrode array with a solution comprising the second polymer in a solvent and

ii) causing the solvent to evaporate from the micro-electrode array.

The solution may be deposited by spin coating, dip coating, spray coating, an ink-jet coating technique or a spray jet coating technique.

The second polymer may be polymerised in situ at the micro-electrode array. The second polymer may be polymerised by a chemical, photochemical or electrochemical technique, or by exposure to ionising radiation, such as X-rays or gamma rays.

The second polymer may be a conducting polymer.

The second polymer may be a non-conducting polymer.

The second polymer may be deposited discretely at a plurality of micro-electrodes.

The second polymer may be deposited as a layer across a substantial portion of the micro-electrode array so as to cover a plurality of micro-electrodes.

An analyte reagent may be immobilised in the second polymer.

An analyte reagent may be disposed on a surface of the second polymer.

Micro-electrode arrays, methods of fabricating same, and methods of sensing an analyte in accordance with the invention will now be described with reference to the accompanying drawings, in which:—

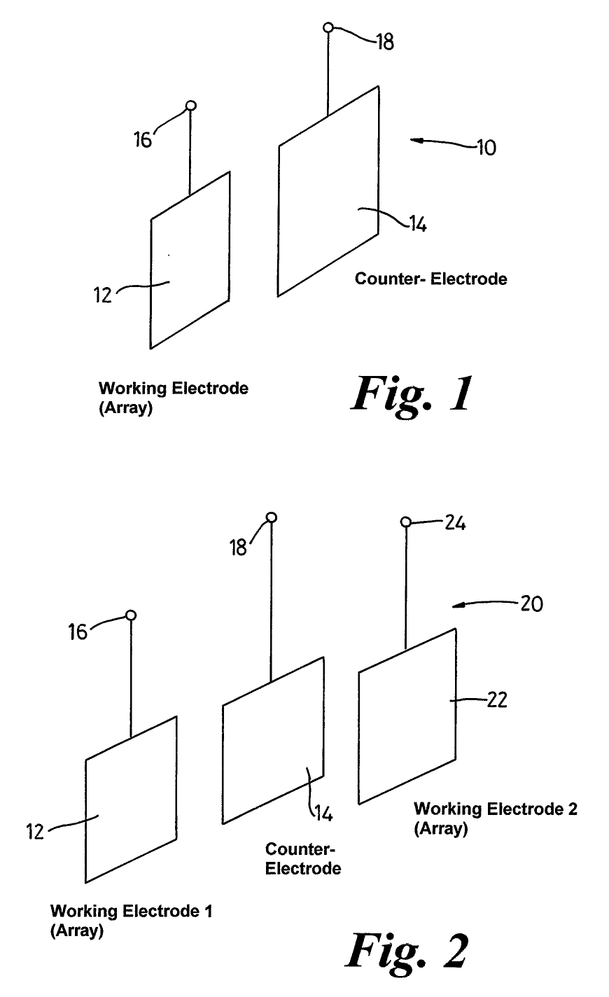

FIG. 1 shows a first analyte sensing arrangement;

FIG. 2 shows a second analyte sensing arrangement;

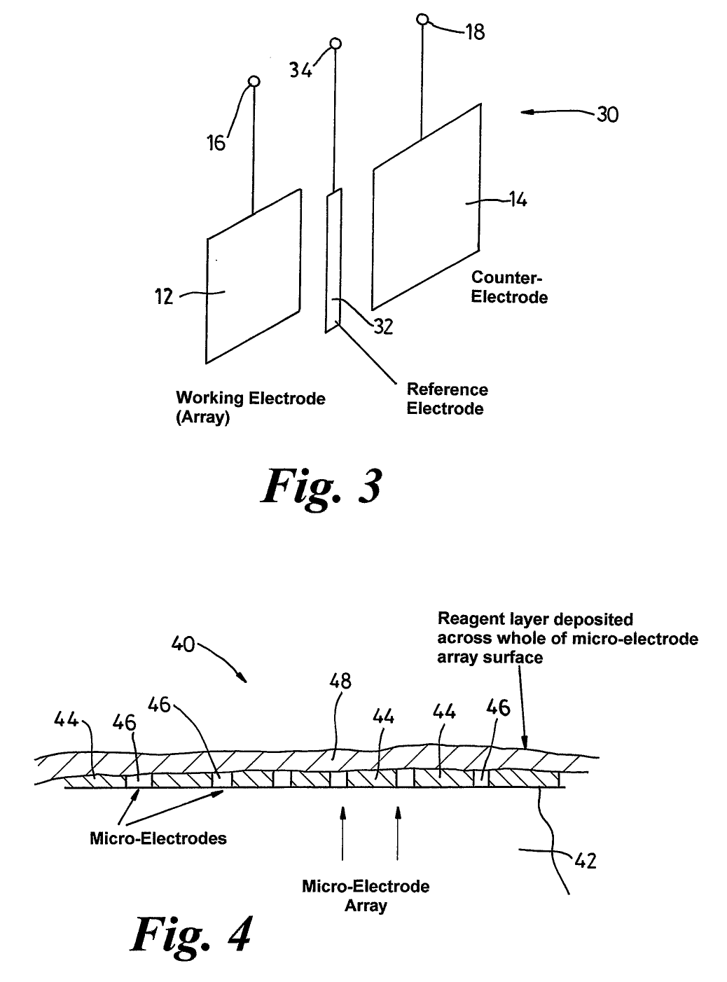

FIG. 3 shows a third analyte sensing arrangement;

FIG. 4 shows a first embodiment of a micro-electrode array;

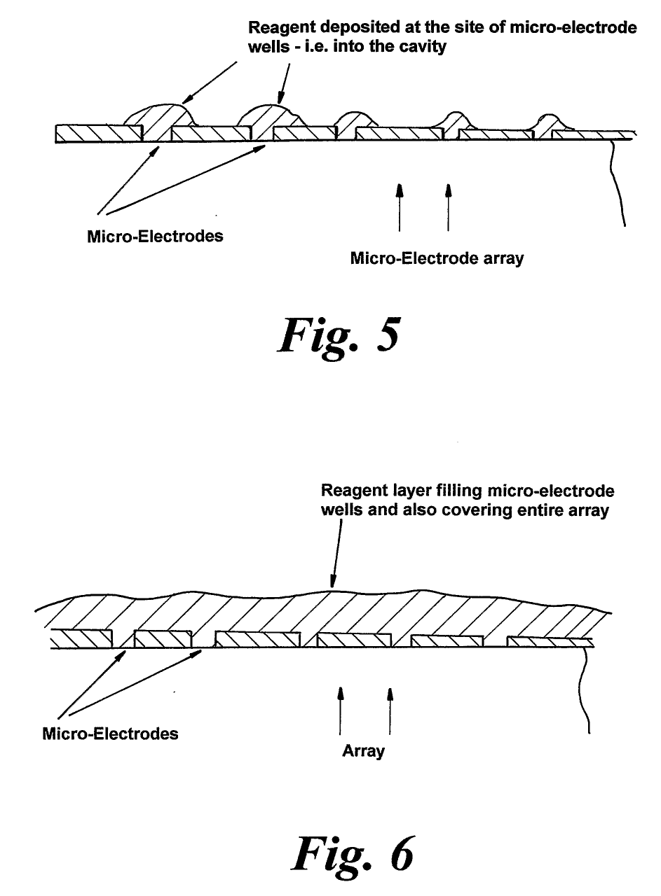

FIG. 5 shows a second embodiment of a micro-electrode array; and

FIG. 6 shows a third embodiment of a micro-electrode array.

FIG. 1 shows a first analyte sensing arrangement, generally shown at 10, comprising a working electrode 12 and a counter-electrode 14. The working electrode 12 is a micro-electrode array. Generally, the analyte sensing arrangement is disposed in a conducting solution, preferably an aqueous solution. Electrical connections are made at 16 and 18 to the working electrode 12 and counter-electrode 14, respectively, to electrical means suitable to enable an electric polarising potential to be applied across the electrodes 12, 14 and to enable interrogation of the working electrode 12 by way of monitoring an electrical property. Interrogation of the working electrode 12 can be performed by monitoring the current that flows between the working electrode 12 and the counter-electrode 14. Interrogation of the working electrode can be performed by linear sweep voltammetry, cyclic voltammetry, square wave voltammetry, pulse voltammetry or other techniques that involve polarising the micro-electrode elements in the working electrode 12 and monitoring the current that flows in response to electrochemistry occurring at the exposed electrode surfaces.

FIG. 2 shows a second embodiment of a sensing arrangement, generally shown at 20, which shares many of the features of the first arrangement shown in FIG. 1. Identical numerals are used to denote such shared features. In the embodiment shown in FIG. 2, a second working electrode 22 is employed, with appropriate electrical connections being made to the working electrode 22 at connection point 24. The working electrode 20 is also a micro-electrode array. The working electrode 12 and second working electrode 20 share a common counter-electrode 14. It may be possible to employ further working electrodes still in combination with a common counter-electrode.

FIG. 3 shows a third embodiment of a sensing arrangement which shares many of the features of the first embodiment shown in FIG. 1. Identical numerals are used to denote such shared features. The third embodiment of a sensing arrangement, shown generally at 30, includes a reference electrode 32 having appropriate electrical connections made at connection point 34.

Other electro-chemical phenomena can be monitored as a means of interrogating the micro-electrode array. For example, the charge accumulated (potential difference) at the surface of a micro-electrode array with respect to a second electrode can be monitored. The second electrode could be a counter-electrode, in which instance an arrangement similar to that shown in FIG. 1 might be employed. Alternatively, the second electrode could be a reference electrode. In some embodiments of this type a potentiometric interrogation technique is used. In other embodiments, capacitive properties of the micro-electrode array solution interface are monitored.

FIG. 4 shows a cross-sectional view of a portion of a first embodiment of a micro-electrode array 40. The micro-electrode array comprises an underlying electrode 42, which may itself be disposed on a substrate (not shown). A layer of insulating polymer 44 is disposed over the electrode 42. The layer of insulating polymer 44 has a plurality of micro-pores 46 formed therein. The micro-pores expose the electrode 42 through the layer of insulating polymer 44, and thus provide a micro-electrode array. The micro-electrode array can be produced generally in accordance with the techniques described in Madigan et al and WO 96/33403. In the first embodiment shown in FIG. 4, an analyte reagent layer 48 is deposited across the whole of the micro-electrode array surface. Surprisingly, it has been found the deposition of the analyte reagent layer across the whole of the array in many instances still results in radial transport of the analyte when the micro-electrode array 40 is used as part of an electrochemical analyte detection system. It should be noted that, as shown in FIG. 4, it is possible that a gap will exist between the analyte reagent layer 48 and the underlying electrode 42 in the vicinity of a micro-pore 46. The gap between the analyte reagent layer 48 and the underlying electrode 42 is approximately equal to the depth of a micro-pore, which in non-limiting embodiments is typically around 30-100 nanometres depending on the insulating polymer used. However, it is also possible (depending on the precise nature of the analyte reagent used) for the micro-pores 46 to be filled with analyte reagent. The present invention encompasses both possibilities.

FIG. 5 shows a cross-sectional view of a portion of a second embodiment of a micro-electrode array 50. The micro-electrode array 50 shares many of the features of the first embodiment of micro-electrode array 40 shown in FIG. 4. Identical numerals are used to denote such shared features. In contrast to the embodiment shown in FIG. 4, in the second embodiment of a micro-electrode array 50, analyte reagent is deposited discretely at the sites of the micro-pores 46. Analyte reagent 52 is deposited into the cavities defined by the micro-pores 46 and, depending on the precise nature of the deposition utilised, may extend above and around each micro-pore 46 somewhat. In contrast to the embodiment shown in FIG. 4, in the second embodiment of a micro-electrode array 50, the analyte reagent 52 is present as a plurality of discrete “islands”—the individual “islands” of analyte reagent 52 are not linked to provide a monolithic layer of the sort associated with the first embodiment of micro-electrode array. The analyte reagent may be deposited directly into the micro-pores 46 by direct surface adsorption onto the electrode 42. Discrete deposition of this type might be accomplished using scanning electrochemistry microscopy. Alternatively, a plurality of matrices in which the analyte reagent is immobilised may be deposited discretely at the micro-pores 46. The matrix in which the analyte reagent is immobilised may be conducting or non-conducting, and may for example be a sol-gel, a protein with chemical cross-linking (eg, albumin chemically cross-linked by heat, or glutaraldehyde or other means), a non-conducting polymer, or a conducting polymer—or other configurations for the immobilisation of the reagents may also be envisaged that achieve the localisation of the analyte reagent at the array.

FIG. 6 shows a cross-sectional view of a portion of a third embodiment of a micro-electrode array 60, which shares many of the features of the first embodiment of a micro-electrode array 40 shown in FIG. 4. Identical numerals are used to denote such shared features. The difference between the third and second embodiments is that an analyte reagent layer 62 is deposited into the wells defined by the micro-pores 46 as well as being deposited as a layer over the micro-pores 46 and covering the entire array. In the first and third embodiments it is possible for the analyte reagent to be immobilised in a matrix.

In further embodiments, it is possible to provide a matrix and to locate analyte reagent on top of the matrix by direct surface adsorption or by coupling to the surface. It is also possible to provide micro-electrode arrays in which one or more analyte reagents are immobilised in a matrix and, additionally, one or more analyte reagents are adsorbed on the surface of the matrix. The analyte reagent(s) adsorbed on the matrix surface may be different to the analyte reagent(s) immobilised in the matrix, but it is also possible that some analyte reagent may be both immobilised and present on the matrix surface. In these instances, it is preferred that the matrix (which may be present as a layer or as discrete depositions at the sites of the micro-electrodes) is a polymer, but other types of matrix are within the scope of the invention.

1-40. (canceled)

41. A method of fabricating a micro-electrode array comprising the steps of:
coating an electrode with an insulating polymer coating by screen printing an insulating polymer onto the electrode and then curing said polymer;
and sonically ablating the insulating polymer coating to produce a plurality of micro-pores.

42. A method according to claim 41 further comprising the step of depositing a second coating onto the micro-electrode array, which coating comprises an analyte reagent.

43. A method according to claim 42 comprising the step of depositing the second coating as a layer across a substantial portion of the micro-electrode array so as to cover a plurality of micro-electrodes.

44. A method according to claim 42 comprising the step of depositing the second coating discretely at a plurality of micro-electrodes.

45. A method according to claim 42 in which the second coating comprises the analyte reagent immobilized within a matrix.

46. A method according to claim 42 in which the second coating comprises the analyte reagent deposited by direct surface adsorption onto the micro-electrode array.

47. A method according to claim 42 in which the second coating comprises a polymer.

48. A micro-electrode array comprising:
an electrode;
an insulating polymer coating covering the electrode and having a plurality of micro-pores formed therein thereby exposing a plurality of micro-electrodes;
and a further coating which comprises an analyte reagent.

49. A micro-electrode according to claim 48 wherein the further coating is deposited as a layer across a substantial portion of the micro-electrode array so as to cover a plurality of micro-electrodes.

50. A micro-electrode according to claim 48 wherein the further coating is deposited discretely at a number of micro-electrodes.

51. A micro-electrode according to claim 48 wherein the further coating comprises a polymer

52. A micro-electrode array according to claim 48 in which the further coating comprises the analyte reagent is deposited by direct surface adsorption onto the micro-electrode array.

53. A micro-electrode array according to claim 48 in which the further coating comprises the analyte reagent immobilized within a matrix.

54. A micro-electrode array according to claim 51 in which the analyte reagent is immobilized in the polymer.

55. A micro-electrode array according to claim 51 in which an analyte reagent is adsorbed onto a surface of the polymer.

56. A method of sensing an analyte using a micro-electrode array according to claim 48, comprising the steps of:
contacting the micro-electrode array with an analyte containment medium, which analyte containment medium contains the analyte;
interrogating the micro-electrode array by polarising the micro-electrodes and monitoring an electrical property that varies due to electrochemistry associated with the analyte; and
correlating the electrical property monitored with the presence of the analyte;
in which the micro-electrode array is interrogated using a voltammetric, potentiometric or capacitive technique.

57. A method according to claim 56 in which the micro-electrode array is interrogated using at least one of: linear sweep voltammetry, cyclic voltammetry, square wave voltammetry and pulse voltammetry.

58. A method according to claim 56 in which the micro-electrode array is interrogated by at least one of: monitoring the current flowing between the micro-electrode array and a counter electrode, and monitoring the potential difference between the micro-electrode array and a second electrode.

59. A method of fabricating a micro-electrode array comprising the steps of:
coating an electrode with an insulating polymer coating;
sonically ablating the insulating polymer coating to produce a plurality of micro-pores; and
depositing a second polymer onto the micro-electrode array by i) contacting the micro-electrode array with a solution comprising the second polymer in a solvent and ii) causing the solvent to evaporate from the micro-electrode array.

60. A method according to claim 59 in which the solution is deposited by spin coating, dip coating, spray coating, an ink-jet coating technique or a spray jet coating technique.

61. A method according to claim 59 in which the second polymer is polymerized in situ at the micro-electrode array.

62. A method according to claim 59 in which the second polymer is deposited discretely at a plurality of micro-electrodes.

63. A method according to claim 59 in which the second polymer is deposited as a layer across a substantial portion of the micro-electrode array so as to cover a plurality of micro-electrodes.

64. A method according to claim 59 in which an analyte reagent is immobilized in the second polymer.

65. A method according to claim 59 in which an analyte reagent is disposed on a surface of the second polymer.
